(19) United States
(12) Patent Application Publication
(10) Pub. No.: US 2004/0010560 A1
(43) Pub. Date: Jan. 15, 2004

(54) Method and apparatus to transmit infrared signals generated from a computer application using a remote device

(76) Inventors: David A. Sandage, Forest Grove, OR (US); Scott W. Watters, Forest Grove, OR (US)

Correspondence Address: INTEL CORPORATION, P.O. BOX 5326, SANTA CLARA, CA, 95056-5326, US

(21) Appl. No.: 10/193,752

(22) Filed: Jul. 10, 2002

(51) Int. Cl. G06F 15/16

(52) U.S. Cl. 709/208; 370/313

(57) ABSTRACT

A method for remotely controlling operations of a target system using a host computer system includes displaying one or more applications executing in the host computer system on a remote controller system. A wireless connection is established between the remote controller system and the host computer system. The remote controller system causes an application executing in the host computer system to issue at least one command to control operations of the target system. The commands are received by the remote controller system and translated into IR signals. IR pulses associated with the IR signals are transmitted by the remote controller system to the target system.

### FIELD OF THE INVENTION

The present invention relates to the field of computing systems, more particularly relating to methods and apparatuses for transmitting infrared (IR) signals.

### BACKGROUND

Computer systems are becoming increasingly pervasive in our society, including everything from small handheld electronic devices, such as personal data assistants and cellular phones, to application-specific electronic devices, such as set-top boxes, digital cameras, and other consumer electronics (e.g., Audio/Video (A/V) systems, etc.), to medium-sized mobile systems such as notebook, sub-notebook, and tablet computers, to desktop systems, workstations, and servers.

As used herein, the term “when” may be used to indicate the temporal nature of an event. For example, the phrase “event ‘A’ occurs when event ‘B’ occurs” is to be interpreted to mean that event A may occur before, during, or after the occurrence of event B, but is nonetheless associated with the occurrence of event B. For example, event A occurs when event B occurs if event A occurs in response to the occurrence of event B or in response to a signal indicating that event B has occurred, is occurring, or will occur.

Computer systems may communicate with one another using wired or wireless technologies. FIG. 1A illustrates one example of a prior art communication using a remote controller system to control operations of a target system in consumer electronics environments. The remote controller system 105 may be used to transmit infrared (IR) signals to the target system (e.g., A/V system, etc.) 120 to control operations of the target system 120. A disadvantage of this set up is that in order for it to be operational, the remote controller system 105 and the target system 120 are required be in the same room or be in a line of sight of one another.

FIG. 1B illustrates another example of a prior art communication using a personal computer system to control operations of a target system. In this example, an IR transmitter 115 is attached to a personal computer system (e.g., a laptop computer system, a desktop computer system etc.) 110. For example, the IR transmitter 115 may be attached to the personal computer system 110 through a serial port. An application may be installed in the personal computer system 110 to allow users to control operations of the target system 120. For example, the application may be an electronic programming guide (EPG) application, and the user at the personal computer system 110 may cause the EPG application to issue commands that cause the IR transmitter 115 to transmit associated IR signals to the target system 120. One disadvantage of this example is that the personal computer system 110 is required to be in the same room or line of sight with the target system 120.

The IR transmitter 115 may be integrated in the personal computer system 110. For example, the personal computer system 110 may be a personal digital assistant (PDA) system such as, for example, a Sony Clié T415, by Sony Electronics Inc., and the application may be the Clié Remote Commander (v. 1.0) application that transforms the Clié T415 into a universal or smart remote controller system. One disadvantage of this example is that the smart remote controller system does not take advantage of the applications available in the personal computer environment including, for example, Windows-based applications or PC browsers-based (e.g., Netscape, Internet Explorer, etc.) applications.

### BRIEF DESCRIPTION OF THE DRAWINGS

The following drawings disclose various embodiments of the present invention for purposes of illustration only and are not intended to limit the scope of the invention.

FIG. 1A illustrates one example of a prior art communication using a remote controller system to control operations of a target system in consumer electronics environments.

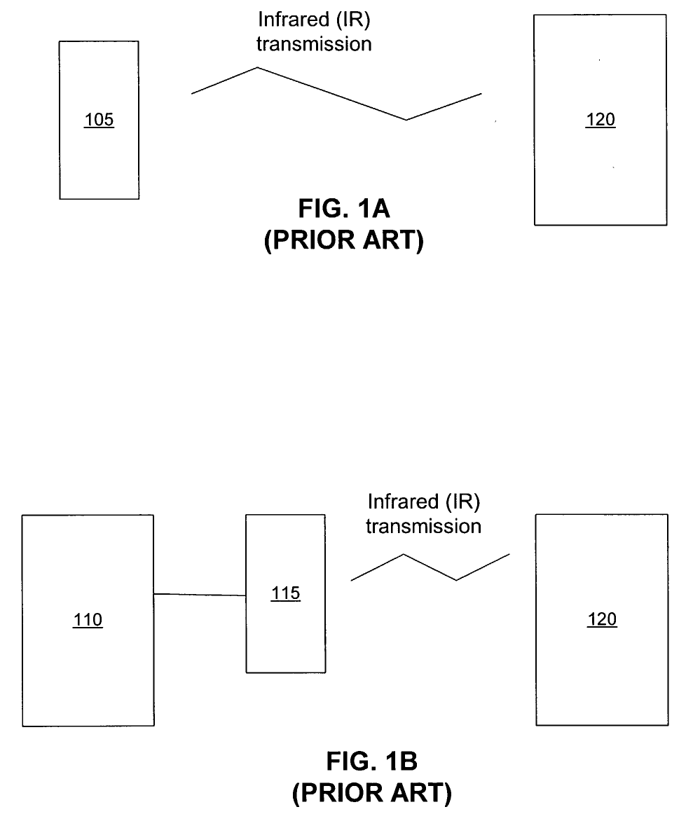

FIG. 1B illustrates another example of a prior art communication using a personal computer system to control operations of a target system. FIG. 2 is a block diagram illustrating a host computer system and a remote controller system in accordance with one embodiment of the invention.

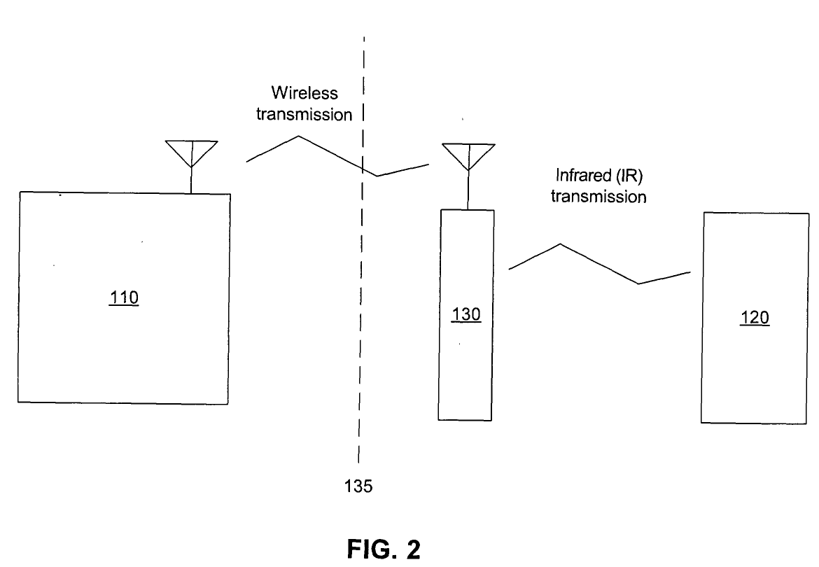

FIG. 3 is a block diagram illustrating examples of components of a host computer system and components of a remote controller system in accordance with one embodiment of the invention.

FIG. 4 is a flow diagram illustrating an example of a process of sending infrared signals using a computer system and a wireless controller in accordance with one embodiment of the invention.

### DETAILED DESCRIPTION

In accordance with one embodiment of the present invention, a remote controller system is used to direct an application executing on a host computer system to issue commands that cause the remote controller system to transmit infrared (IR) signals to control operations of a target system.

FIG. 2 is a block diagram illustrating a host computer system and a remote controller system in accordance with one embodiment of the invention. The host computer system 110 may be a personal computer system such as, for example, a desktop computer system, etc. The host computer system 110 may provide an execution environment for one or more applications capable of issuing commands to control operations of the target system 120. For one embodiment, a remote controller system 130 is connected to the host computer system 110 using a wireless connection. The remote controller system 130 may be in the same room with the host computer system 110. Alternatively, the remote controller system 130 and the host computer system 110 may be in different rooms, separated by, for example, a wall 135.

For one embodiment, the remote controller system 130 and the host computer system 110 communicates with one another over the wireless connection using a terminal server protocol that, among other functionalities, enables the remote controller system 130 to display the applications executing in the host computer system 110. The terminal server protocol may also enable the host computer system 110 to receive inputs entered from the remote controller system 130. For example, the terminal server protocol may be the Remote Desktop Protocol (RDP) from Microsoft Corporation of Redmond, Wash.

Using RDP, the applications executing in the host computer system 110 may be remotely displayed in the remote controller system 130. This may include, for example, displaying the user interface (UI) in the remote controller system 130. If the user is able to access the UI of the host computer system 110 remotely, the user may control the applications in the host computer system 110 without having to be in the same room with the host computer system 110. In this example, the remote controller system 130 may be referred to as a thin client or a terminal, and the host computer system 110 may be referred to as a terminal server. For example, the remote controller system 130 may be implemented using the “Mira” technology by Microsoft Corporation, and a stylus may be used as an input device for a user at the remote controller system 130. A thin client is a device that relies on a terminal server for application execution and data. The thin client may perform little or no application processing. For example the thin client may require relatively small amounts of memory and disk storage capability.

Referring to FIG. 2, the remote controller system 130 may include a transmitter (not shown) capable of transmitting IR signals to control operations of a target system 120. The target system 120 (e.g., an A/V system) may include an IR receiver (not shown) to receive IR signals transmitted by the remote controller system 130. The remote controller system 130 may have been programmed so that it can transmit the IR pulses that the target system 120 understands. With the embodiment illustrated in FIG. 2, it may not be necessary for the target system 120 to be in the same room as the host system 110 in order to be able to remotely control the target system 120 using IR.

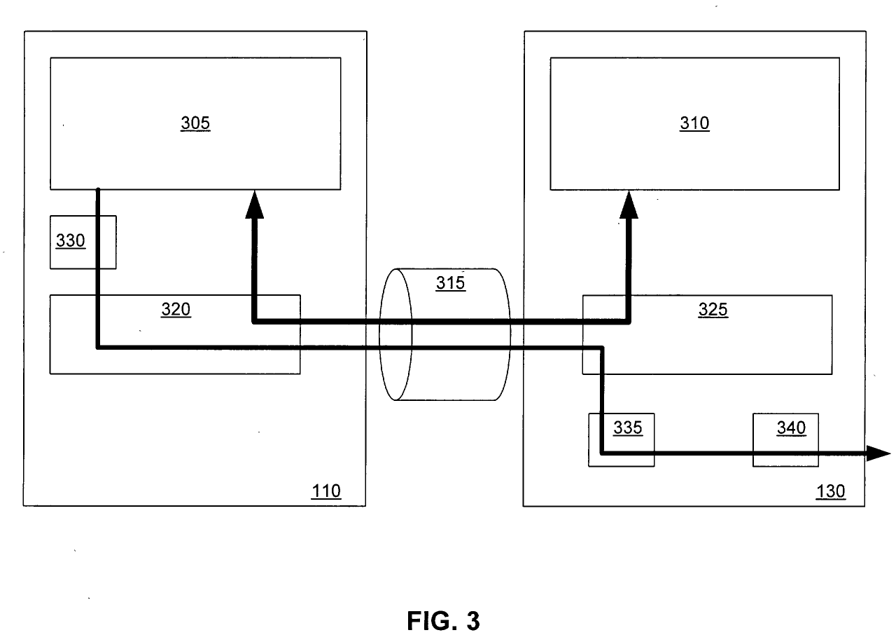

FIG. 3 is a block diagram illustrating examples of some components of a host computer system and some components of a remote controller system in accordance with one embodiment of the invention. The host computer system 110 may include an application execution environment 305 for executions of one or more applications. For one embodiment, using a virtual channel facility provided by RDP, an RDP connection 315 may be established between an RDP server 320 (or a server module) in the host computer system 110 and an RDP client 325 (or a client module) in the remote controller system 130. The RDP connection 315 may allow data (e.g., the application UI) to flow between the host computer system 110 and the remote controller system 130. For example, the RDP connection 315 may allow the applications executing in the application environment 305 to be displayed in a remote display environment 310 in the remote controller system 130. The RDP connection 315 may also allow the remote controller system 130 to control executions of the applications in the application execution environment 305.

For one embodiment, within the RDP connection 315, a virtual channel (not shown) is established to carry commands. For example, commands issued by the applications, may be transmitted by a host IR interface 330 (or host module) in the host computer system 110 to a remote IR interface 335 (or remote module) in the remote controller system 130. Using the remote controller system 130, the user may access a host-based application (e.g., a Window-based application) in the host computer system 110 to control the target system 120. The host-based application may send high-level commands such as, for example, “power on”, “play”, “channel up”, “channel down”, “volume up”, “volume down”, “pause”, etc. to the host IR interface 330 in the host computer system 110 using, for example, standard Windows-style application programming interface (API). The commands may then be sent from the host IR interface 330 to the remote IR interface 335 using the virtual channel established within the RDP connection 315.

For one embodiment, the remote controller system 130 may include a consumer IR interface 340 (or consumer module). The consumer IR interface 340 may be capable of transmitting IR pulses to the target system 120. When the remote IR interface 335 receives the commands from the host IR interface 330, the commands may then be translated into associated IR signals. The remote IR interface 335 may then send the associated IR signals to the consumer IR interface 340. The consumer IR interface 340 may then transmit the associated IR signals to the target system 120. Although the translation of the commands into the associated IR signals has been described as being performed by the remote IR interface 335, it may instead be performed by the host IR interface 330 or the consumer IR interface 340 or a combination of two or more of these interfaces. The translation may be performed in software, hardware or a combination of both software and hardware.

For one embodiment, the host IR interface 330 may be a software module that resides in the host computer system 110 running Windows XP from Microsoft Corporation. The host IR interface 330 may provide an API that allows an application executing in the host computer system 110 to send consumer IR commands. The host IR interface 330 may then take these commands and pass them to the remote IR interface 335 using the virtual channel 315. There may be different ways to implement the host IR interface 330. For example, the host IR interface 330 may be a persistent XP Service that is loaded if the host computer system 110 starts up. The application executing in the host computer system 110 may then use some form of procedure calls to call into the host IR interface 330. The host IR interface 330 may be implemented in software, hardware, or a combination of both software and hardware. For example, the host IR interface 330 may be implemented as a Windows DLL (dynamic link library) that is linked with the application. As another example, functionality of the host IR interface 330 may be programmed as part of the application itself. For one embodiment, the DLL implementation is be used because the DLL may be used by any application in the host computer system 110.

The remote IR interface 335 is the counterpart of the host IR interface 330 and communicates with the host IR interface 330 using the RDP connection 315. The remote IR interface 335 may be implemented in software, hardware, or a combination of both software and hardware. For example, the remote IR interface 335 may be implemented as a DLL that is resident in the remote controller system 130. The RDP client 325 may load the remote IR interface 335 when a connection is made to the host computer system 110. The remote IR interface 335 accepts the commands over the RDP connection 315 from the host IR interface 330 and passes the associated IR signals (e.g., consumer IR command codes) to the consumer IR interface 340. For one embodiment, the remote controller system 130 may be a Mira system running Windows CE from Microsoft Corporation. For one embodiment, the consumer IR interface 340 may be implemented in hardware. Alternatively, it may be implemented in software or a combination of hardware and software.

The consumer IR interface 340 may then produce the actual IR pulses that are transmitted to the target system 120. For example, the consumer IR interface 340 may consist of a chip from Universal Electronics Inc. in Cypress, Calif. that looks like an RS-232 serial port. The remote IR interface 335 may then use standard Windows CE methods to open the serial port and transmit a string of command codes. The consumer IR interface 340 then knows how to interpret the command codes and convert them into the IR pulses for the specified function in the specified target system 120.

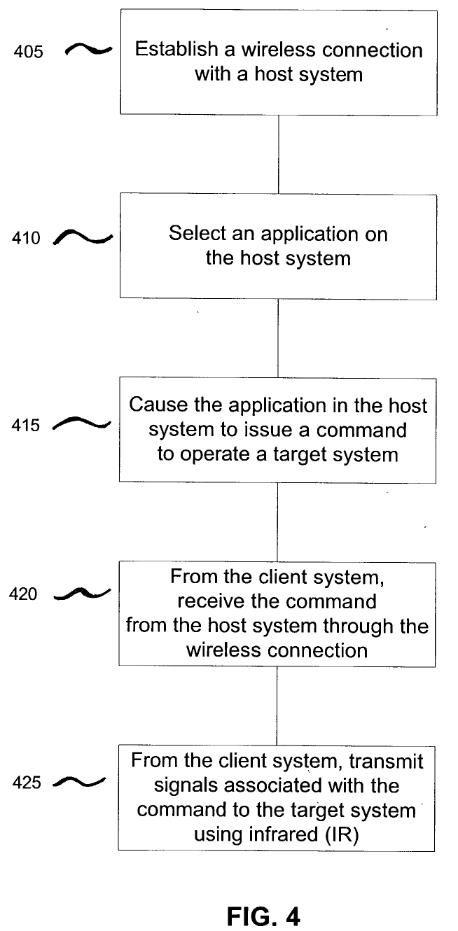

FIG. 4 is a flow diagram illustrating an example of a process of sending infrared signals using a computer system and a wireless controller in accordance with one embodiment of the invention. In this example, the process may be performed by the remote controller system (or client system) 130. At block 405, a wireless connection is established between the remote controller system 130 and the host computer system 110. This may include, for example, the RDP client 325 establishing the RDP connection 315 with the RDP server 320 in the host computer system 110. This may also include, for example, the RDP client loading the remote IR interface 335. As described above, the RDP connection 315 may enable the remote controller system 130 to display applications (e.g., the Windows desktop applications) executing in the host computer system 110. For example, while the application is running in the host computer system 110, the user interface (UI) of the application may be displayed in the remote controller system 130.

At block 410, from the remote controller system 130, an application in the host computer system 110 is selected for execution. For example, the user using the remote controller system 130 may select to execute a consumer IR application (e.g., an EPG application, a universal remote application, etc.) in the host computer system 110.

At block 415, the application is caused to issue one or more commands to operate a target system 120. For example, the user may select a control function of the application to cause the application to issue one or more high-level commands to control the target system 120 (e.g., a television, a A/R receiver, etc.). The application may then call the host IR interface 330 using, for example, the API of the host IR interface 330.

The host IR interface 330 may then send the command over the virtual channel (within the RDP connection 315) to the remote controller system 130. For one embodiment, the host IR interface 330 may translate the command to associated IR signals and then transmit the IR signals to the remote controller system 130. For another embodiment, as illustrated in block 420, the host IR interface 330 may transmit the command to the remote controller system 130 and the translation of the command to the IR signals is performed by the remote IR interface 335. For example, the remote IR interface 335 may translate the high-level command for “channel up” to the appropriate IR signals for the make and model of a television target system. The remote IR interface 335 then sends the IR signals to the consumer IR interface 340. At block 425, the consumer IR interface 340 may convert the IR signals to IR pulses and then transmits the IR pulses to the target system 130.

The operations of these various methods may be implemented by a processor in a computer system, which executes sequences of computer program instructions which are stored in a memory which may be considered to be a machine-readable storage media. For example, the computer system may be the remote controller system 130. The memory may be random access memory (RAM), read only memory (ROM), a persistent storage memory, such as mass storage device or any combination of these devices. Execution of the sequences of instruction causes the processor to perform operations according to one embodiment the present invention such as, for example, the operations described in FIG. 4.

Methods and apparatuses for controlling operations of systems from remote locations using IR have been disclosed. For one embodiment, the method combines the benefits of the development and execution environment of the personal computer as a host computer system with the portability of a remote controller system to operate a target system. The target system may not be required to be in the same room with the host computer system.

Although the present invention has been described with reference to specific exemplary embodiments, it will be evident that various modifications and changes may be made to these embodiments without departing from the broader spirit and scope of the invention as set forth in the claims. For example, although the embodiments described above refer to transmitting high-level commands, the embodiments may also be used to transmit low-level bit streams. Accordingly, the specification and drawings are to be regarded in an illustrative rather than a restrictive sense.

What is claimed is:

1. A network, comprising:
a base system for executing at least one application to control operation of at least one target system; and
a remote system coupled to the base system, the remote system displaying the application executing in the base system using a wireless protocol, the remote system used to direct the application to issue at least one command to control the operation of the target system.

2. The network of claim 1, wherein the wireless protocol is remote desktop protocol (RDP).

3. The network of claim 2, wherein the remote system displays the application executing in the base system using RDP.

4. The network of claim 1, wherein the command is transmitted from the base system to the remote system.

5. The network of claim 4, wherein the remote system translates the command to infrared (IR) signals and transmits IR pulses associated with the IR signals to the target system.

6. The network of claim 1, wherein the command is translated to associated IR signals by the base system, and wherein the IR signals are transmitted from the base system to the remote system.

7. The network of claim 6, wherein the remote system transmits IR pulses associated with the IR signals to the target system.

8. The network of claim 1, wherein the application is an electronic programming guide (EPG) application, and wherein the target system is an audio/video system.

9. A method, comprising:
enabling a user to control at least one target system using at least one application executing in a host system from a client system, wherein said enabling comprises:
establishing a connection between the host system and the client system using a wireless protocol, the connection allowing the application to be displayed in the client system;
from the client system, causing the application to issue at least one command to control operation of the target device; and
from the host system, responsive to the application issuing the command, transmitting a first signal to the client system.

10. The method of claim 9, further comprising:
from the client system, responsive to receiving the first signal from the host system, transmitting a second signal to the target device, the second signal controls the operation of the target device.

11. The method of claim 10, wherein the second signal is transmitted using infrared (IR).

12. The method of claim 9, wherein transmitting the first signal to the client system comprises translating the command to the first signal.

13. The method of claim 9, wherein the wireless protocol is remote desktop protocol (RDP).

14. The method of claim 9, wherein the host system and the target system are not in a line of sight of one another.

15. The method of claim 9, wherein the host system and the client system are not in a line of sight of one another.

16. An apparatus, comprising:
a client module to communicate with a host system through a wireless connection, wherein the client module enables remote display of at least one application executing in the host system, and wherein the client module further enables causing the application to issue at least one command to control a target system; and
a remote module coupled to the client module, the remote module receiving the command from the host system through the wireless connection, wherein the command is translated to IR signals to control the target system.

17. The apparatus of claim 16, further comprising a consumer module coupled to the remote module, wherein the consumer module receives the IR signals from the remote module and transmits associated IR pulses to the target system.

18. The apparatus of claim 16, wherein the wireless connection is a remote desktop protocol (RDP) connection.

19. An article of manufacture, comprising:
a machine-accessible medium including data that, when accessed by a machine, cause the machine to performs operations comprising:
establishing a connection between a host system and a client system using a wireless protocol, the connection allowing an application executing in the host system to be displayed in the client system;
from the client system, causing the application to issue at least one command to control operation of a target system; and
from the host system, responsive to the application issuing the command, transmitting the command to the client system, wherein the client system translates the command to infrared (IR) signals to control the target system.

20. The article of manufacture of claim 19, wherein the wireless protocol is remote desktop protocol (RDP).

21. A method, comprising:
using a wireless protocol that enables displaying on a remote system at least one application executing on a host system to allow a user at the remote system to control operation of a target system using infrared (IR).

22. The method of claim 21, wherein the wireless protocol is remote desktop protocol (RDP).

23. The method of claim 21, wherein the target system is not in a line of sight with the host system.

24. The method of claim 21, wherein the remote system and the target system are in a line of sight of one another.
